(19) United States
(12) Patent Application Publication
(10) Pub. No.: US 2006/0274284 A1
(43) Pub. Date: Dec. 7, 2006

(54) ILLUMINATION ARRANGEMENTS FOR COLORED LIGHT SOURCES

(75) Inventors: Mark D. Peterson, Lake Oswego, OR (US); Jeffrey A. Gohman, Hillsboro, OR (US)

Correspondence Address: SCHWABE, WILLIAMSON & WYATT, P.C., PACWEST CENTER, SUITE 1900, 1211 SW FIFTH AVENUE, PORTLAND, OR, 97204, US

(73) Assignee: InFocus Corporation, Wilsonville, OR (US)

(21) Appl. No.: 11/421,417

(22) Filed: May 31, 2006

Related U.S. Application Data
(60) Provisional application No. 60/686,344, filed on May 31, 2005.

(51) Int. Cl. G03B 21/14

(52) U.S. Cl. 353/84

(57) ABSTRACT

Embodiments of apparatuses, articles, methods, and systems for illumination arrangements for combining light paths of colored light sources are generally described herein. Other embodiments may be described and claimed.

### RELATED APPLICATION

The present application is a non-provisional application of provisional application No. 60/686,344, filed on May 31, 2005, entitled “ILLUMINATION ARRANGEMENTS FOR COLORED LIGHT EMITTING DEVICES,” and claims priority to said provisional application. The specification of said provisional application is also hereby fully incorporated by reference in its entirety, except for those sections, if any, that are inconsistent with this specification

### FIELD

Disclosed embodiments of the present invention relate to the field of projection systems, and more particularly to the combination of light paths from light sources in such projection systems.

### BACKGROUND

Multimedia projection systems have become popular for purposes such as conducting sales demonstrations, business meetings, classroom training, and for use in home theaters. In typical operation, multimedia projection systems receive video signals from a data source and convert the video signals to digital information to control one or more digitally driven light valves. Based on this digital information the light valves may manipulate incident light into image bearing light that represents the video image. High-energy discharge lamps emitting polychromatic light have often been used in prior art projection systems. These prior art projection systems suffer from a number of disadvantages including a short lamp life and reduced brightness after an initial period of usage. Additionally, there is a significant amount of resources directed to dividing the polychromatic light in order to selectively manipulate light of the primary colors.

Recent focus has turned to developing and manufacturing projection systems employing and utilizing the monochromatic light of solid state light sources, which are less affected by the shortcomings of polychromatic light sources. One challenge of using multiple monochromatic light sources in projection systems is to combine the light from the light sources, while being cognizant of the reliability, performance, package dimensions, and cost of the projection systems.

### BRIEF DESCRIPTION OF THE DRAWINGS

Embodiments of the invention are illustrated by way of example and not by way of limitation in the figures of the accompanying drawings, in which the like references indicate similar elements and in which:

FIG. 1 illustrates an illumination arrangement in accordance with an embodiment of the present invention;

FIG. 2 illustrates an illumination arrangement in accordance with another embodiment of the present invention;

FIG. 3 illustrates an illumination arrangement in accordance with another embodiment of the present invention;

FIG. 4 illustrates an illumination arrangement in accordance with another embodiment of the present invention;

FIG. 5 illustrates an illumination arrangement in accordance with another embodiment of the present invention;

FIG. 6 illustrates an illumination arrangement in accordance with another embodiment of the present invention;

FIG. 7 illustrates an illumination arrangement in accordance with another embodiment of the present invention;

FIG. 8 illustrates an illumination arrangement in accordance with another embodiment of the present invention;

FIG. 9 illustrates an illumination arrangement in accordance with another embodiment of the present invention;

FIG. 10 illustrates an illumination arrangement in accordance with another embodiment of the present invention; and

FIG. 11 illustrates a projection system in accordance with an embodiment of the present invention.

### DETAILED DESCRIPTION OF EMBODIMENTS OF THE INVENTION

In the following detailed description reference is made to the accompanying drawings that form a part hereof, wherein like numerals designate like parts throughout, and in which is shown, by way of illustration, specific embodiments in which the invention may be practiced. It is to be understood that other embodiments may be utilized and structural or logical changes may be made without departing from the scope of the embodiments of the present invention. Directions such as up, down, back, and front may be used in the discussion of the drawings. These directions are used to facilitate the discussion and are not intended to restrict the application of embodiments of this invention. Therefore, the following detailed description is not to be taken in a limiting sense and the scope of the embodiments of the present invention are defined by the appended claims and their equivalents.

For the purposes of the present invention, the phrase “A/B” means A or B; the phrase “A and/or B” means “(A), (B), or (A and B)”; the phrase “A, B, and/or C” means “(A), (B), (C), (A and B), (A and C), (B and C), or (A, B and C)”; and the phrase “(A)B” means “(B) or (AB),” that is, A is an optional element.

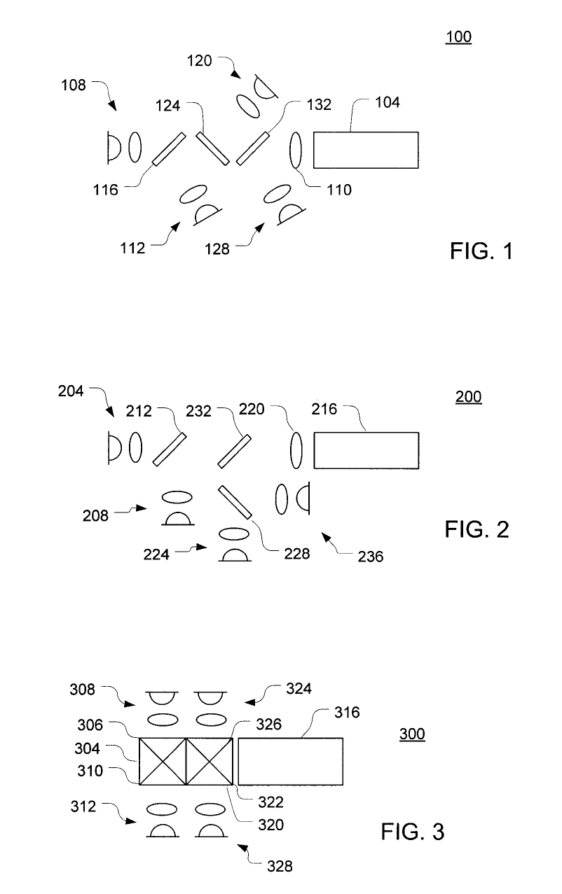

FIG. 1 illustrates an illumination arrangement 100 for use in a projection system in accordance with an embodiment of the present invention. The illumination arrangement 100 may combine light from a number of colored light sources into an integration device 104, e.g., a light tunnel, flys eye lenses, etc. In this embodiment a green light source 108 may provide light within a range of wavelengths corresponding to green light to the integration device 104 along a light path with substantially the same optical axis as the integration device 104. The light source 108 may be optically coupled with the integration device 104 through a number of filters and lens 110.

In one embodiment, another green light source 112 may also provide light within the green wavelength range, e.g., 500-560 nanometers (nm). A filter 116 may be adapted to transmit light from the light source 108 and reflect light from the light source 112 toward the integrating device 104.

In an embodiment, the two green light sources 108 and 112 may provide green light with slightly different wavelengths. In this embodiment, the filter 116 may be a dichroic filter adapted to allow light from the green light source 108 to pass, while reflecting light from the green light source 112. For example, the green light source 108 may provide light with an average wavelength of approximately 540 nanometers (nm), while the green light source 112 may provide light with an average wavelength of approximately 520 nm. The filter 116 may be a dichroic edge filter adapted to allow light with wavelengths greater than 530 nm to pass while reflecting light with wavelengths below 530 nm.

In another embodiment, the filter 116 may be a polarization filter adapted to reflect light of one polarization and to transmit light of an orthogonal polarization. For example, the light source 108 may emit vertically polarized light and the light source 112 may emit horizontally polarized light. In this embodiment, the filter 116 may transmit horizontally polarized light, such as the light from the light source 112, and reflect vertically polarized light, such as the light from the light source 108.

In various embodiments, the light sources 108 and/or 112 may have a variety of polarization components adapted to result in the emission of appropriately polarized light. Furthermore, in various embodiments additional/alternative polarizations may be used.

A blue light source 120 may provide light within the blue wavelength range, e.g., 440-485 nm. A filter 124 may reflect the light from the blue light source 120 and allow light from the green light sources 108 and 112 to pass.

A red light source 128 may provide light within the red wavelength range, e.g., 625-740 nm. A filter 132 may reflect light from the red light source 128 towards the integration device 104, and transmit light from the green light sources 108 and 112 and from the blue light source 120.

In various embodiments, illumination arrangements described herein may have modifications such as adding/removing light sources, additional/alternative colors (e.g., yellow and/or cyan), and/or alternative placements of the colored light sources with appropriate modifications to the filters used.

In one embodiment, filters may include dichroic interference filters. In other embodiments, other types of filters such as other interference filters may be utilized. Additionally, the filters may be notch filters and/or edge filters as appropriate. For example, while the above embodiment teaches combining green light with filter 116, other embodiments may additionally/alternatively combine other like-colored light paths in a similar manner.

Illumination arrangements described herein may allow the flexibility of increasing the intensity of one or more colors by adding light sources of that color. Increasing the intensity of a particular color may be desirable in order to obtain a more preferred color balance for the projection system. Illumination arrangements of the present embodiment may also increase the color gamut by allowing for more colored light sources (e.g., yellow and/or cyan) to be employed. These arrangements may also help to reduce the cost and overall dimensions of the projector system, compared to having separate integrating tunnels for each color. Furthermore, the light from the light sources may be presented to the tunnel along a single light path. The single light path may assist in the conservation of the projection system's étendue, or light throughput, by presenting different colored light having similar illumination areas and angles to downstream components.

As shown, each of the colored light sources 108, 112, 120, and 128 include a light emitting device and a lenses. Other embodiments may include additional/alternative components, e.g., mirrors, polarization elements, etc. The light emitting device may comprise solid-state light sources such as, but not limited to, light-emitting diodes and/or laser diodes.

FIG. 2 illustrates an illumination arrangement 200 in accordance with another embodiment of the present invention. In this embodiment, light from green light sources 204 and 208 may be combined with a filter 212, similar to the above embodiment. The green light sources 204 and 208 may be optically coupled with a integration device 216 through a number of filters and a lens 220.

A red light source 224 may provide red light to be transmitted through a filter 228 and reflected off of a filter 232 towards the integration device 216.

A blue light source 236 may provide blue light that is reflected off of the filter 228 and the filter 232 towards the integration device 216.

FIG. 3 illustrates an illumination arrangement 300 in accordance with another embodiment of the present invention. In this embodiment, filters may be crossed and embedded within a transparent cube-like structure that may be referred to as an X-cube. A first X-cube 304 may have a filter 306 adapted to reflect green light from a green light source 308 and transmit blue light from a blue light source 312. The first X-cube 304 may also have a filter 310 adapted to reflect blue light from the blue light source 312 and to transmit green light from the light source 308. The green and blue light may be transmitted from the first X-cube towards downstream components, e.g., an integration device 316.

A second X-cube 320 may be adapted to transmit light from the blue light source 312 and the green light source 308 to the integration device 316. The second X-cube may have a filter 322 that is also adapted to reflect light from a green light source 324 and transmit light from a red light source 328, and transmit. Similar to the embodiment discussed above with respect to FIG. 1, the filter 322 may distinguish between light from green light source 324 and light from green light source 308 based at least in part on differing wavelength and/or polarization.

The second X-cube may also have a filter 326 adapted to transmit light from the green light source 324 and reflect light from the red light source 328. In one embodiment, the integration device 316 may be adjacent to the second X-cube 320. In other embodiments, a lens may positioned between the two components.

In various embodiments, an additional light source may be placed on the face of the X-cube 304 opposite the tunnel 316 and/or additional X-cubes may be added.

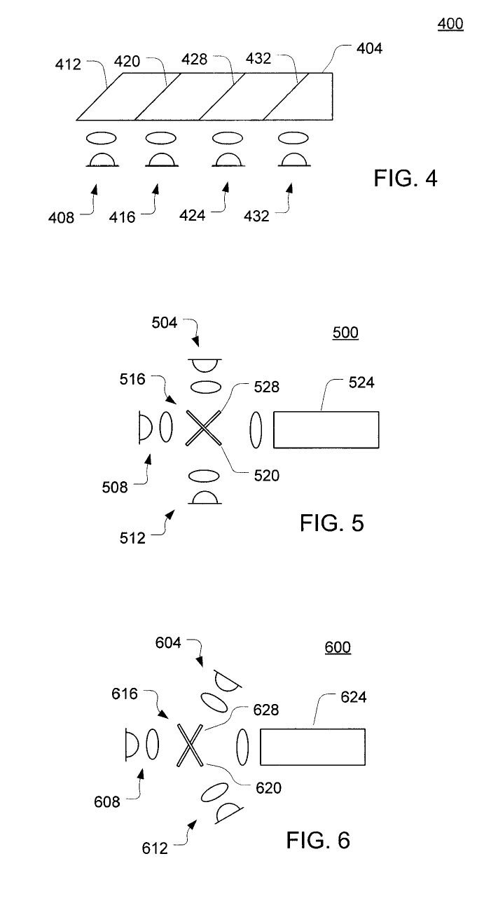

FIG. 4 illustrates an illumination arrangement 400 in accordance with another embodiment of the present invention. In this embodiment an integration device 404 may have one or more filters embedded therein. A green light source 408 may be placed on a side of the integration device 404 and be adapted to provide green light to a filter/mirror 412. The filter/mirror 412 may reflect the green light downstream through a number of other filters in the integration device 404. A second green light source 416 may be placed adjacent to the first green light source 408. A filter 420 may reflect the light from the second green light source 416 and transmit the light from the first green light source 408, similar to above embodiments.

A red light source 424, placed adjacent the second green light source 416, may provide red light that may be reflected off of a filter 428. The filter 428 may be adapted to transmit green light from the green light sources 408 and 416.

A blue light source 432, placed adjacent to the red light source 424, may provide blue light that may be reflected off of a filter 436. The filter 436 may be adapted to transmit green and red light.

In this embodiment, the light sources 408, 416, 424, and 432 may be arranged in the same plane. This planar configuration may allow for the precise placement of the light emitting devices with, e.g., a pick-and-place machine, on a common board. This may, in turn, facilitate the alignment and/or the reduction in manufacturing costs. Additionally, this may facilitate the cooling of the light emitting devices. The cooling of the devices could take place by thermally coupling a heat sink to the board and/or by directing an air current over the devices.

In various embodiments, other light sources may be additionally/alternative placed on the upstream end of the integration device 404 and/or the side opposite from where the light sources are located as depicted in FIG. 4.

FIG. 5 illustrates an illumination arrangement 500 in accordance with another embodiment of the present invention. In this embodiment a red light source 504, a green light source 508, and a blue light source 512 may provide red light, green light, and blue light, respectively, to a crossed-filter device 516. The crossed filter device 516 may have a filter 520 adapted to reflect red light and transmit blue light and green light towards an integration device 524. The crossed filter device 516 may also have a filter 528 adapted to reflect blue light and transmit red light and green light towards the integration device 520.

FIG. 6 illustrates an illumination arrangement 600 in accordance with another embodiment of the present invention. In this embodiment a red light source 604, a green light source 608, and a blue light source 612 may provide red light, green light, and blue light, respectively, to a crossed filter device 616. The crossed filter device 616 may have a filter 620 adapted to reflect red light and transmit blue light and green light towards an integration device 624. The crossed filter device 616 may also have a filter 628 adapted to reflect blue light and transmit red and green light towards the integration device 620.

In this embodiment, the filter 628 may be disposed substantially parallel/collinear with a light path of the light received from the red light source 604. This arrangement may allow a portion of the red light to be incident on the filter 620 and reflected towards the tunnel 624 without being transmitted through the filter 628. Additionally, the amount of red light incident upon the intersection of the filter 620 and the filter 628, where filtering may be inconsistent, may be reduced. This orientation of the red light source 604 and the crossed filter device 616 may lessen the amount of red light that gets inadvertently filtered.

As used herein, a filter may be parallel/collinear with a light path if a line in the plane of the filter is parallel/collinear with the light path.

Similar to filter 628, the filter 620 may be disposed substantially parallel/collinear with a light path of the light received from the light source 612. Likewise, this orientation may lessen the amount of blue light that gets inadvertently filtered. In this embodiment a filter angle φ of approximately 30 degrees may be formed at the intersection between the filter 620 and the filter 628.

A filter angle φ of approximately 30 degrees, along with relative positioning of light sources 604 and 612, may result in a lower angle of incidence on the reflective filter (as compared to having a 45 degree filter angle φ. This may be beneficial (for both polarizations) by reducing an occurrence of s-p polarization splitting, which may, in turn, result in higher reflection rates of the light.

The transmissive light path, e.g., from the green light source 608, may encounter an increased cross-sectional area at the intersection of the two filters 620 and 628 as the filter angle φ decreases. Therefore, in one embodiment, this cross-sectional area may be reduced by using relatively thin (e.g., 0.7 millimeters (mm), 0.5 mm, or even 0.3 mm) filters. This may facilitate a reduction in the loss of light for the transmissive path at the intersection.

Furthermore, having thin filters may reduce the surface area orthogonal to the collinear/parallel light path. In some embodiments edges of the filters 620 and 628 may also be cut at angles other than 90 degrees (e.g., at 60 degrees) to decrease this surface area.

FIG. 7 illustrates an illumination arrangement 700 in accordance with an embodiment of the present invention. In this embodiment a red light source 704, a green light source 708, and a blue light source 712 may provide red light, green light, and blue light, respectively, to a crossed filter device 716. The crossed filter device 716 may have a filter 720 adapted to reflect red light and transmit blue light and green light towards a integration device 724. The crossed filter device 716 may also have a filter 728 adapted to reflect blue light and transmit red and green light towards a integration device 720. In this embodiment, the filters 720 and 728 may be arranged with a 30 degree filter angle, similar to the above embodiment. However, in this embodiment the light sources 704, 708, and 712 may be positioned in substantially the same plane, and may include reflecting devices, e.g., fold mirrors 732, 736, and 740 to respectively couple the red, green, and blue light to the crossed filter device 616. The planar configuration of the light sources 704, 708, and 712 may share similarities with the embodiment described and discussed with reference to FIG. 4. Additionally, alignment of images of the light sources 704, 708, and/or 712 at the entrance of the integration device 724 may be adjusted by adjusting the respective fold mirrors 732, 736, and 740.

Other embodiments described and discussed in accordance with embodiments of the present invention may be amenable, with proper modifications, to coupling light from light sources arranged in a planar configuration with reflecting devices similar to this embodiment.

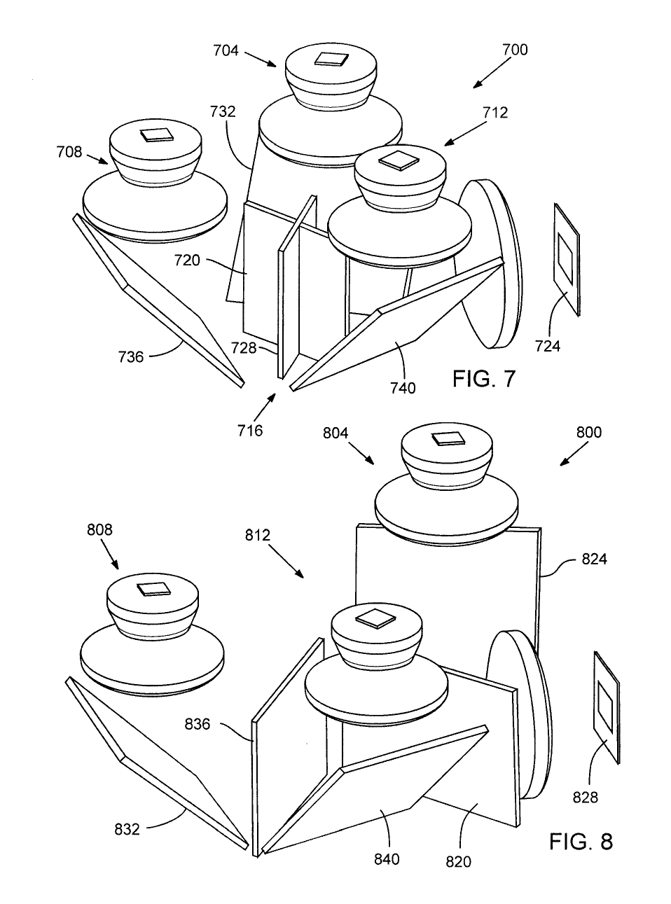

FIG. 8 illustrates an illumination arrangement 800 in accordance with another embodiment of the present invention. In this embodiment a red light source 804, a green light source 808, and a blue light source 812 may provide red light, green light, and blue light, respectively. The red light source 804 may include a fold mirror 824 to direct the light towards a filter 820. The filter 820 may be adapted to reflect red light and transmit blue light and green light towards an integration device 828. Light from the green light source 808 may be reflected off of a reflecting device 832 and towards the tunnel 828 through a filter 836 and the filter 820. The filter 836 may be adapted to transmit the green light and reflect blue light, which is received from the blue light source 812 via a reflecting device 840. Similar to the above embodiment, the light sources 804, 808, and 812 may be in a substantially planar relationship with one another.

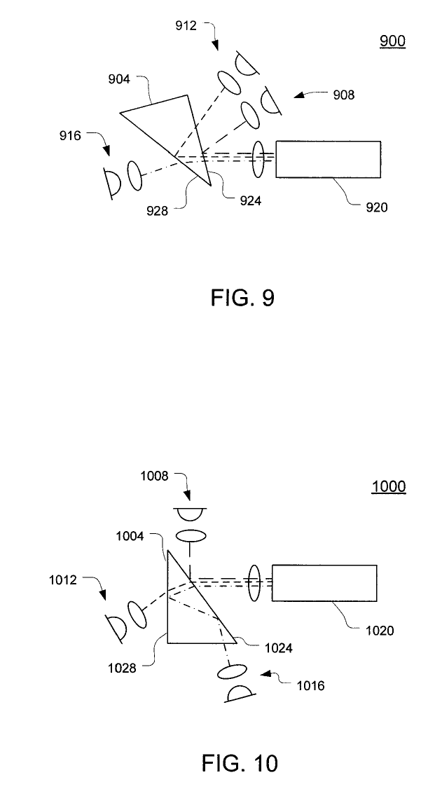

FIG. 9 illustrates an illumination arrangement 900 in accordance with another embodiment of the present invention. In this embodiment, a prism 904 may be arranged to receive light from a red light source 908, a green light source 912, and a blue light source 916 and direct the received light towards an integration device 920. The prism 904 may have a filter coating 924, on a first surface, which is adapted to transmit green light from the light source 916 through to a second surface. The prism 904 may also have a filter coating 928, on the second surface, which may be adapted to reflect the green light back towards the integration device 920. The filter coating 928 may be further adapted to transmit blue light from the light source 916. The filter coating 924 may be further adapted to reflect red light from the light source 908 while transmitting blue and green light.

Placing filter coatings on surfaces of a prism may facilitate the alignment of the filters.

The light paths are shown separate from one another for clarity of the description. Embodiments of the present invention may include co-linear light paths.

In this embodiment, the selective reflection and/or transmission of the filter coating 924 and filter coating 928 may facilitate reduction of the colored light paths to a substantially common output light path to the integration device 920.

FIG. 10 illustrates an illumination arrangement 1000 in accordance with another embodiment of the present invention. In this embodiment, a prism 1004 may be arranged to receive light from a red light source 1008, a green light source 1012, and a blue light source 1016 and direct the received light towards a tunnel 1020. This embodiment may facilitate having the light sources placed apart from one another to allow, e.g., separate heat sinks.

The prism 1004 may have a filter coating 1024 on a first surface adapted to reflect red light from the light source 1008 and to transmit green and blue light from the green and blue light sources 1012 and 1016, respectively. The prism 1004 may also have a filter coating 1028 on a second surface adapted to transmit green light from the light source 1012 and to reflect blue light from the light source 1016. In this embodiment, the blue light from the light source 1016 may be internally reflected from the first surface prior to being reflected from the filter coating 1028 at the second surface.

Similar to the above embodiments, the light paths are shown separate from one another for clarity of the description. Embodiments of the present invention may include co-linear light paths.

In this embodiment, similar to the embodiment described with reference to FIG. 9, the selective reflection and/or transmission of the filter coating 1024 and filter coating 1028 may facilitate reduction of the colored light paths to a substantially common output light path to the integration device 920.

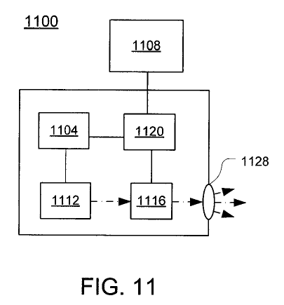

FIG. 11 illustrates a projection system 1100 in accordance with an embodiment of the present invention. In this embodiment, the projection system 1100 may include a projection device 1104, e.g., a projector or a projection television, coupled to a data source 1108. In various embodiments the data source 1108 may be, but is not limited to, a personal or laptop computer, an integrated television tuner, a digital versatile disk (DVD), a set-top box (STB), or a video camera.

The projection device 1104 may include an illumination arrangement 1112 similar to any of the illumination arrangements described and discussed above. Light emitted from the illumination arrangement 1112 may propagate along a light path to illuminate an imaging device such as a light modulator 1116. The light modulator 1112 may include, but is not limited to, a digital micromirror device (DMD), a reflective liquid crystal on semiconductor (LCOS) device, and a liquid crystal device (LCD).

The light modulator 1116 may modulate the light based on control signals provided to the light modulator 1116 from a controller 1120. The controller 1120 may receive color image data representing a color image from the data source 1108 and process the image data into constituent color data (e.g., red, green, and blue data). The constituent color data may then be conveyed to the light modulator 1116 in proper synchronism with signals sent to a power supply 1124 that control emission time frames of the corresponding constituent colored light sources (e.g., red, green, and blue light sources) of the illumination arrangement 1112. In various embodiments, the controller may include a general-purpose processor/controller, an application specific integrated circuit (ASIC), or a programmable logic device (PLD).

For the purpose of this description, a still image may be considered as a degenerate or special video where there is only one frame. Accordingly, both still image and video terminologies may be used in the description to follow, and they are not to be construed to limit the embodiments of the present invention to the rendering of one or the other.

An image of the light modulator 1116 may be projected for viewing by a projection lens 1128. Various optical components may be placed in the light paths to adjust for specific design factors associated with a given embodiment.

In one embodiment, the optical components may be held together by an optical frame within a projector housing (not shown). The housing may be mechanically rigid and be designed to facilitate the dissipation of heat. The frame and housing may be adapted to accommodate a cooling fan for cooling the optical components by generating an airflow. The power supply may also be used to power the cooling fan and a controller.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. An apparatus comprising:
a first light source adapted to provide light within a first range of wavelengths corresponding to a first color;
a second light source adapted to provide light within the first range of wavelengths; and
a filter disposed substantially at an intersection of a first light path of light provided by the first light source and a second light path of light provided by the second light source and adapted to transmit light provided by the first light source and to reflect light provided by the second light source along the first light path.

2. The apparatus of claim 1, wherein the filter comprises a dichroic filter.

3. The apparatus of claim 2, wherein the dichroic filter is an edge filter.

4. The apparatus of claim 3, wherein the edge filter is adapted to transmit light with wavelengths greater than approximately 530 nanometers and to reflect light with wavelengths less than approximately 530 nanometers.

5. The apparatus of claim 1, wherein the filter comprises a polarization filter.

6. The apparatus of claim 1, wherein the filter is a first filter and the intersection is a first intersection and the apparatus further comprises:
a third light source adapted to provide light within a second range of wavelengths corresponding to a second color; and
a second filter disposed substantially at a second intersection of the first light path and a third light path of light provided by the third light source and adapted to reflect light within the second range of wavelengths received from the third light source and to transmit light within the first range of wavelengths received from the first and second light sources.

7. The apparatus of claim 6, further comprising:
a fourth light source adapted to provide light within a third range of wavelengths corresponding to a third color; and
a third filter disposed substantially at a third intersection of the first light path and a fourth light path of light provided by the fourth light source and adapted to reflect light of the third color received from the fourth light source, to transmit light within the first range of wavelengths received from the first and second light sources, and to transmit light within the second range of wavelengths received from the third light source.

8. The apparatus of claim 7, wherein the first, second, and third colors are green, blue, and red, respectively.

9. The apparatus of claim 1, wherein the filter is disposed within an X-cube.

10. The apparatus of claim 1, wherein the filter is disposed within an integration device.

11. A method comprising:
receiving, with a filter disposed substantially at an intersection, light within a first range of wavelengths corresponding to a first color along a first light path and a second light path that traverses the first light path at the intersection;
transmitting, through the filter, light within the first range of wavelengths received along the first light path; and
reflecting, from the filter, light within the first range of wavelengths received along the second light path.

12. The method of claim 11, further comprising:
providing light within the first range of wavelengths along the first light path with a first light source; and
providing light within the first range of wavelengths along the second light path with a second light source.

13. The method of claim 11, wherein the filter is a first filter and the intersection is a first intersection and the method further comprises:
providing light within a second range of wavelengths corresponding to a second color with a third light source along a third light path that traverses the first light path at a second intersection;
reflecting, from a second filter disposed substantially at the second intersection, light within the second range of wavelengths received from the third light source; and
transmitting, through the second filter, light within the first range of wavelengths received from the first and second light sources.

14. The method of claim 13, further comprising:
providing light within a third range of wavelengths corresponding to a third color with a fourth light source along a fourth light path that traverses the first light path at a third intersection;
reflecting, from a third filter disposed substantially at the third intersection, light within the third range of wavelengths received from the fourth light source; and
transmitting, through the third filter, light within the first range of wavelengths received from the first and second light sources and light within the second range of wavelengths received from the third light source.

15. A system comprising:
an illumination arrangement including
a first light source adapted to provide light within a first range of wavelengths corresponding to a first color;
a second light source adapted to provide light within the first range of wavelengths; and
a filter disposed substantially at an intersection of a first light path of light provided by the first light source and a second light path of light provided by the second light source and adapted to transmit light provided by the first light source and to reflect light provided by the second light source along the first light path; and
a plurality of projection components adapted to receive light from the illumination arrangement and to modulate the light into a projected image.

16. The system of claim 15, wherein said plurality of projection components comprise:
an integration device adapted to receive light from the illumination arrangement and to integrate the received light; and
a light modulator adapted to receive the integrated light and to modulate the received integrated light into a predetermined image.

17. The system of claim 15, wherein said plurality of projection components further comprise:
a projection lens to project an image of the light modulator.

18. An apparatus comprising:
a first light source adapted to provide light of a first color along a first light path;
a second light source adapted to provide light of a second color along a second light path; and
a crossed filter device having
a first filter disposed substantially parallel or collinear with the first light path and adapted to transmit light of the first color and reflect light of the second color; and
a second filter disposed substantially parallel or collinear with the second light path and adapted to transmit light of the second color and reflect light of the first color.

19. The apparatus of claim 18, wherein the first filter and the second filter are further adapted to transmit light of a third color and the apparatus further comprising:
a third light source adapted to provide light of the third color along a third light path that is transverse to the first and second filter.

20. The apparatus of claim 18, further comprising:
a plurality of projection components to receive light from the crossed filter device and to modulate the light into a projected image.

21. The apparatus of claim 20, wherein the projection components comprise:
an integration device adapted to receive light from the crossed filter device and to integrate the received light.

22. The apparatus of claim 21, wherein the projection components further comprise:
a light modulator adapted to receive the integrated light and to module the light into a predetermined image.

23. The apparatus of claim 18, wherein the first and second filters comprise first and second dichroic filters, respectively.

24. The apparatus of claim 18, wherein the first and second filters comprise a first and second polarization filters, respectively.

25. The apparatus of claim 18, where said first, second, and third colors comprise blue, green, and red, respectively.

26. A method comprising:
providing light of a first color to a crossed filter device along a first light path that is substantially parallel or collinear with a first filter of the crossed filter device; and
providing light of a second color to the crossed filter device along a second light path that is substantially parallel or collinear with a second filter of the crossed filter device.

27. The method of claim 26, further comprising:
providing light of a third color to the crossed filter device along a third light path that is transverse to the first and second filters.

28. The method of claim 27, further comprising:
reflecting, with the first filter, light of the second color;
transmitting, through the first filter, light of the first and third colors;
reflecting, with the second filter, light of the first color; and
transmitting, through the second filter, light of the second and third colors.

29. An apparatus comprising:
a first light source adapted to provide light of a first color;
a second light source adapted to provide light of a second color;
a third light source adapted to provide light of a third color; and
a prism, having a first filter coating disposed on a first surface and a second filter coating disposed on a second surface, the first and second filters adapted to selectively transmit and/or reflect light, the prism adapted to receive light of the first, second, and third colors from the first, second, and third light sources, respectively, and to output the received light along a substantially common light path based at least in part on selective transmission and/or reflection of light by the first and second filter coatings.

30. The apparatus of claim 29, wherein the first light source is adapted to provide the light of the first color along a first light path that intersects with the prism at the first surface and the second light source is adapted to provide the light of the second color along a second light path that intersects with the prism at the second surface.
